(19) United States
(12) Patent Application Publication
(10) Pub. No.: US 2011/0076009 A1
(43) Pub. Date: Mar. 31, 2011

(54) OPTICAL AXIS ADJUSTING APPARATUS AND OPTICAL AXIS ADJUSTING METHOD

(75) Inventors: Masahiko SATO, Kawasaki (JP); Jun MATSUEDA, Kawasaki (JP); Yukihiko OHASHI, Kawasaki (JP); Yoshinori HINO, Kawasaki (JP)

(73) Assignee: FUJITSU LIMITED, Kawasaki-shi (JP)

(21) Appl. No.: 12/887,625

(22) Filed: Sep. 22, 2010

(30) Foreign Application Priority Data
Sep. 24, 2009 (JP) 2009-219651

(51) Int. Cl. H04J 14/00

(52) U.S. Cl. 398/1

(57) ABSTRACT

An optical axis adjusting apparatus for an optical device includes a drive unit moving an optical component through which communication light emitted from a light source passes, a plate member disposed facing the optical component, the plate member allowing light to transmit through the plate member and reflecting light to the optical component, a photographing unit disposed on a back side of the plate member, taking an image irradiated with the light transmitted through the plate member, and a control section controlling the drive unit to move the optical component based on the image and information on optical characteristics of the light reflected by the plate member.

### CROSS-REFERENCE TO RELATED APPLICATIONS

This application is based upon and claims the benefit of priority of the prior Japanese Patent Application No. 2009-219651, filed on Sep. 24, 2009, the entire contents of which are incorporated herein by reference.

### FIELD

The embodiments discussed herein are related to an optical axis adjusting apparatus and an optical axis adjusting method.

### BACKGROUND

Optical devices such as Wavelength Selectable Switches (WSS) and optical matrix switches are used to select an optical path or switch between optical paths.

In such optical devices, communication light emitted from a light source is caused to pass through optical components such as optical fibers and lenses. The optical device switches between paths of the communication light using a mirror array including a plurality of micro-mirrors driven by a MEMS (Micro Electro Mechanical System). The mirror array is disposed at a position at which the communication light having passed through the optical components is condensed on the optical axis. Thus, it is necessary to adjust the optical axis such that the communication light input from the light source is reflected in the optical device to exhibit appropriate optical characteristics at the position of output. Japanese Laid-open Patent Publication No. 2007-212678 discloses an optical axis adjusting method for a wavelength selectable switch.

Many components are disposed on the paths of the communication light in the optical device. The optical axis is adjusted by comprehensively adjusting such components. The optical axis is adjusted using the optical characteristics of the communication light, such as an Insertion Loss (IL), wavelength characteristics, and crosstalk, as indices, for example. Such indices do not directly indicate the angle or the position of the optical components, and therefore it is difficult to determine the arrangement of the optical components on the basis of the indices.

In the case where the optical axis is to be adjusted using the optical characteristics, the optical characteristics may be grasped after adjustment is performed such that the reflected communication light appropriately returns to the position of output. However, the optical components may be arranged in numerous ways, which makes it very difficult even to roughly adjust the optical axis for the purpose of grasping the optical characteristics. The adjustment work may be especially difficult in the case where the optical axis must be adjusted for a plurality of paths.

In view of the foregoing, it is an object of the invention disclosed herein to make adjustment of the optical axis of an optical device easier.

### SUMMARY

According to an embodiment, an optical axis adjusting apparatus for an optical device includes a drive unit moving an optical component through which communication light emitted from a light source passes, a plate member disposed facing the optical component, the plate member allowing light to transmit through the plate member and reflecting light to the optical component, a photographing unit disposed on a back side of the plate member, taking an image irradiated with the light transmitted through the plate member, and a control section controlling the drive unit to move the optical component based on the image and information on optical characteristics of the light reflected by the plate member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 schematically illustrates a wavelength selectable switch;

FIG. 2A is a side view of the wavelength selectable switch seen in the X-axis direction;

FIG. 2B is a side view of the wavelength selectable switch seen in the Y-axis direction;

FIG. 3A illustrates a mirror array;

FIG. 3B illustrates the mirror array;

FIG. 3C illustrates the mirror array;

FIG. 4 illustrates an optical axis adjusting system;

FIG. 5A illustrates a target mask;

FIG. 5B illustrates the target mask;

FIG. 5C illustrates the target mask;

FIG. 6A illustrates the positional relationship between the target mask and a camera;

FIG. 6B illustrates the positional relationship between the target mask and the camera;

FIG. 7 illustrates an optical axis adjusting method;

FIG. 8 illustrates an angle adjusting method for an optical fiber array;

FIG. 9A illustrates the optical fiber array during angle adjustment;

FIG. 9B illustrates the optical fiber array during the angle adjustment;

FIG. 10 illustrates a peak search;

FIG. 11 illustrates a focal point adjusting method for a condensing lens;

FIG. 12 illustrates a position adjusting method for the optical fiber array;

FIG. 13A illustrates the optical fiber array during position adjustment;

FIG. 13B illustrates the optical fiber array during the position adjustment;

FIG. 14A illustrates photographing information;

FIG. 14B illustrates the photographing information;

FIG. 15A illustrates a recognition process for the target mask;

FIG. 15B illustrates the recognition process for the target mask;

FIG. 16 illustrates a recognition processing method for spot light;

FIG. 17A illustrates a recognition process for the spot light;

FIG. 17B illustrates the recognition process for the spot light;

FIG. 17C illustrates the recognition process for the spot light;

FIG. 17D illustrates the recognition process for the spot light;

FIG. 18 illustrates an inclination adjusting method for the optical fiber array;

FIG. 19 illustrates inclination adjustment for the optical fiber array;

FIG. 20 illustrates a method for adjusting the interval between the condensing lens and a correcting lens;

FIG. 21A illustrates adjustment of the interval between the condensing lens and the correcting lens; and

FIG. 21B illustrates the adjustment of the interval between the condensing lens and the correcting lens.

### DESCRIPTION OF EMBODIMENTS

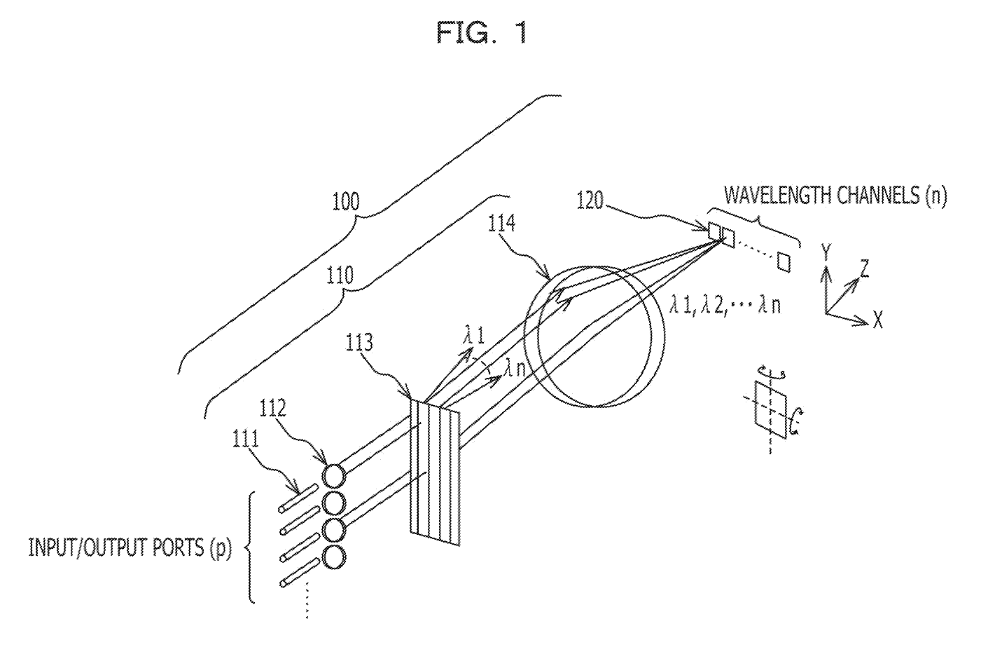

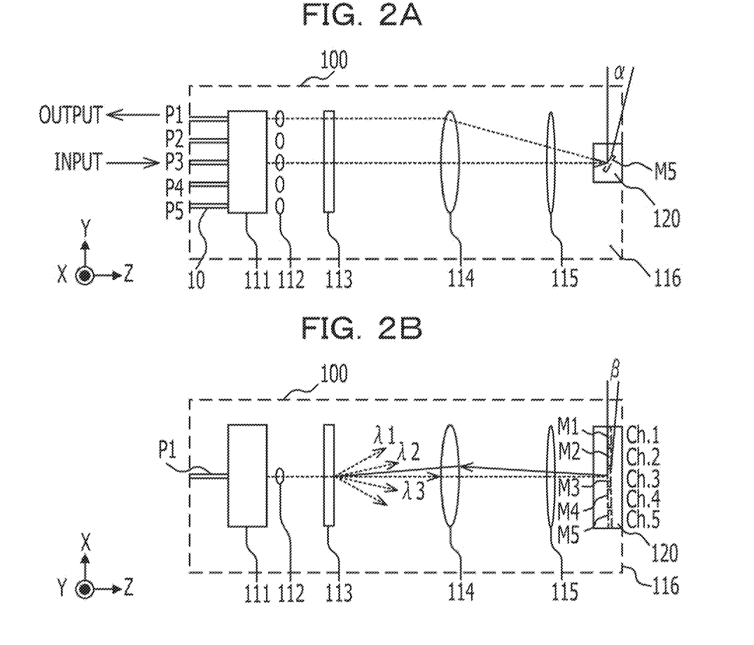

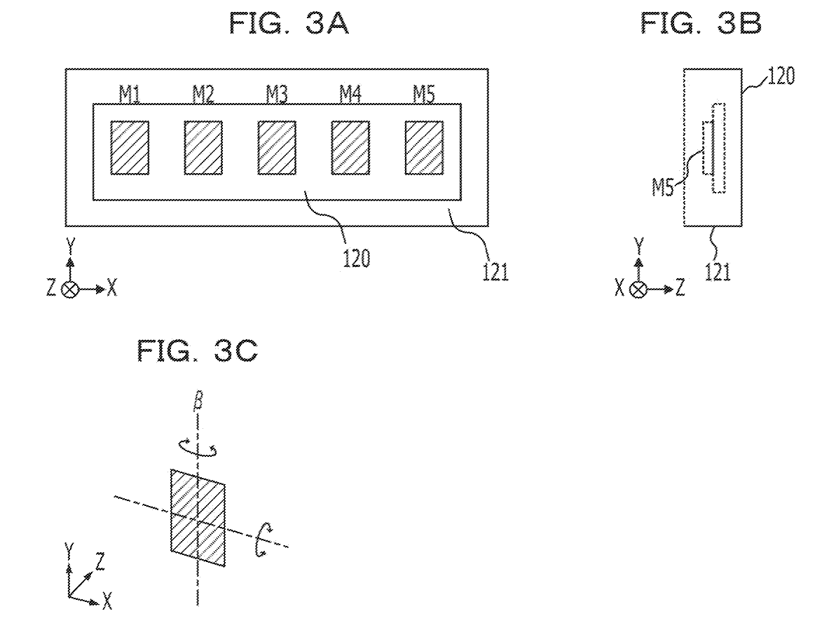

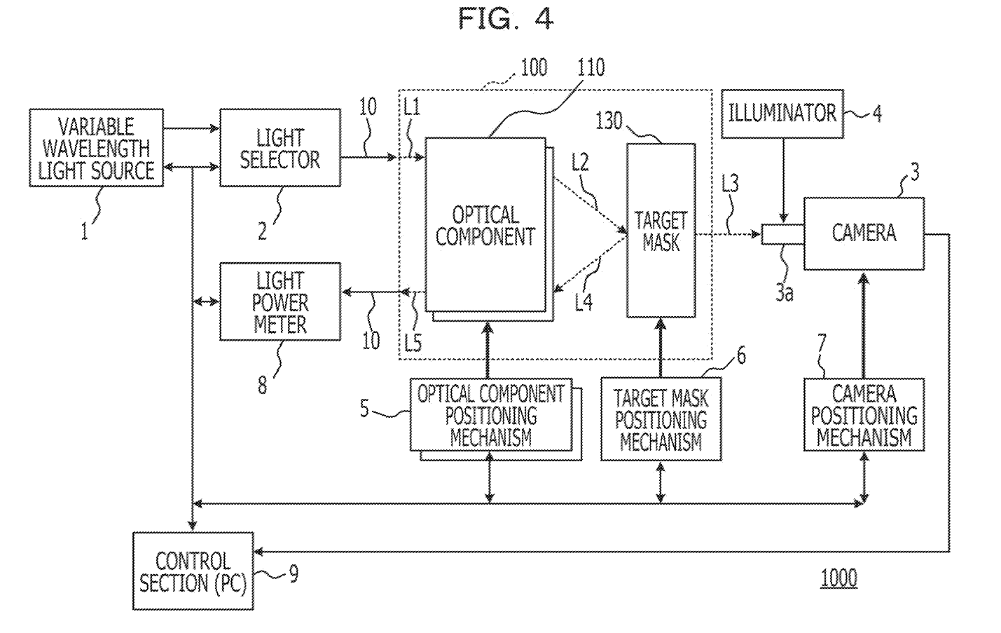

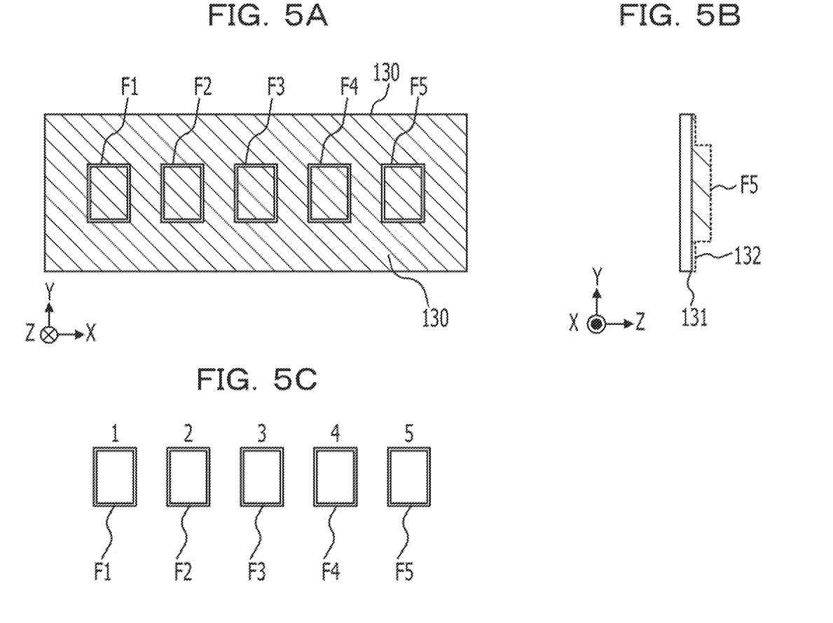

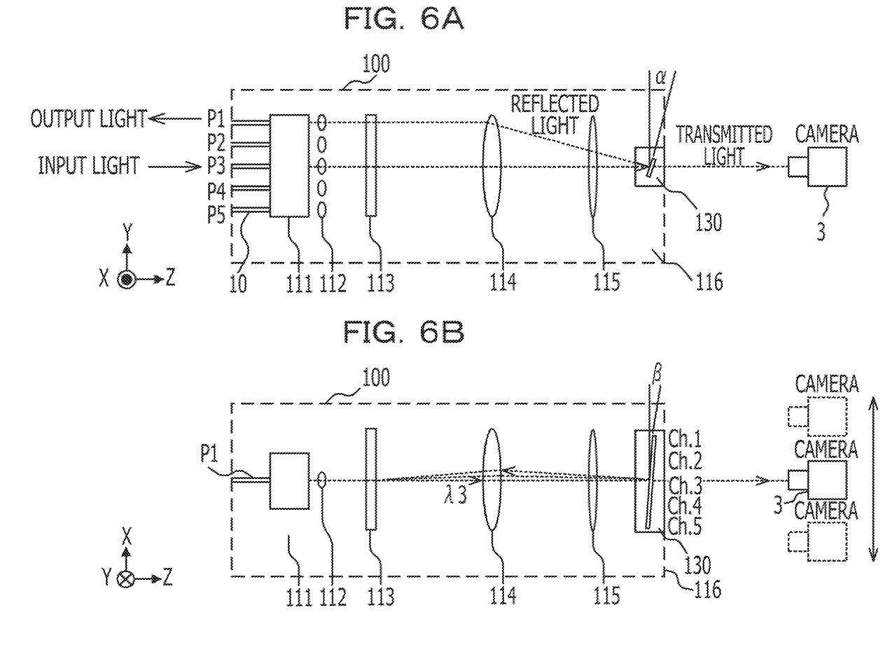

FIG. 1 illustrates a wavelength selectable switch 100. An optical axis adjusting system 1000 (see FIG. 4) disclosed herein adjusts the optical axis of the wavelength selectable switch 100. FIGS. 2A and 2B illustrate the wavelength selectable switch 100. FIGS. 3A to 3C illustrate a mirror array 120 included in the wavelength selectable switch 100. FIG. 4 illustrates the optical axis adjusting system 1000. FIGS. 5A to 5C illustrate a target mask 130. FIGS. 6A and 6B illustrate the positional relationship between the target mask 130 and a camera 3.

In the following description, the X-, Y-, and Z-axis directions of the wavelength selectable switch 100 are defined as indicated in FIG. 1. FIG. 2A is a side view of the wavelength selectable switch 100 seen in the X-axis direction. FIG. 2B is a side view of the wavelength selectable switch 100 seen in the Y-axis direction.

The wavelength selectable switch 100 includes a plurality of types of optical components 110, a frame 116 housing the optical components 110, and a mirror array 120. The optical components 110 include an optical fiber array 111, a micro-lens array 112, a diffraction grating 113, a condensing lens 114, and a correcting lens 115.

Communication light is input to and output from the wavelength selectable switch 100 through the optical fiber array 111 which houses p optical fibers 10 held in an aligned state. The optical fibers 10 are used for Wavelength Division Multiplexing (WDM) communication, and a plurality (n) of communication lights at wavelengths λ(n) are multiplexed to pass through each of the optical fibers 10. The optical fiber array 111 is provided with the micro-lens array 112, and is formed with input/output ports (p) including p ports. Each of micro-lenses included in the micro-lens array 112 is disposed at an end of each optical fiber 10 to couple space propagating light.

The wavelength selectable switch 100 includes the diffraction grating 113 which serves as a spectroscopic element. The diffraction grating 113 is disposed facing the optical fiber array 111. The diffraction grating 113 disperses the communication light (input light) having passed through the optical fibers 10 in accordance with the wavelength. The wavelength selectable switch 100 includes the condensing lens 114 provided on the back side of the diffraction grating 113. The wavelength selectable switch 100 also includes the correcting lens 115 provided on the back side of the condensing lens 114 as illustrated in FIGS. 2A and 2B. The correcting lens 115 is not illustrated in FIG. 1.

The condensing lens 114 and the correcting lens 115 are adjusted in position in the direction of the optical axis (Z-axis) to finely adjust the focal point and the light condensing position on a reflective surface of the mirror array 120 to be discussed later.

The wavelength selectable switch 100 includes the mirror array 120 provided on the back side of the condensing lens 114. The correcting lens 115 is disposed between the condensing lens 114 and the mirror array 120. The mirror array 120 includes a plurality of micro-mirrors. In the embodiment, the mirror array 120 includes five micro-mirrors M1 to M5. The communication light dispersed by the diffraction grating 113 is condensed on the reflective surface of the mirror array 120 through the condensing lens 114 and the correcting lens 115.

While the five micro-mirrors M1 to M5 are illustrated in FIGS. 2A and 2B, the number of micro-mirrors is not limited to five. That is, the number of micro-mirrors may be varied in accordance with the specifications of the device.

FIGS. 3A to 3C illustrate the mirror array 120. FIG. 3A is a front view of the mirror array 120. FIG. 3B is a side view of the mirror array 120. The plurality of micro-mirrors M1 to M5 are enclosed in a package 121 having an opening on the side of the reflective surfaces of the mirrors.

Rotation of each of the micro-mirrors M1 to M5 about the X-axis is represented by an angle α as illustrated in FIG. 2A. Rotation of each of the micro-mirrors M1 to M5 about the Y-axis is represented by an angle β as illustrated in FIG. 2B.

Each of the micro-mirrors M1 to M5 is independently rotated about the X-axis and the Y-axis by a MEMS as illustrated in FIG. 3C. The MEMS controls the angle at which each of the micro-mirrors M1 to M5 reflects the communication light to selectively switch between optical paths for input to and output from the optical fiber array 111.

The number of micro-mirrors corresponds to the number of wavelength channels for use as communication wavelength bands. The micro-mirrors are disposed in series. Each wavelength channel has its center wavelength and bandwidth. The center of each micro-mirror is equivalent to the center wavelength, and the direction in which the micro-mirrors M1 to M5 are arranged is equivalent to the communication wavelength band. The micro-mirrors M1 to M5 correspond to five frequency channels Ch. 1 to Ch. 5. In the embodiment, five input/output ports P1 to P5 are provided in correspondence with the five frequency channels Ch. 1 to Ch. 5.

FIGS. 2A and 2B illustrate an optical path. In the optical path, communication light at a wavelength λ3 input from the input/output port P3 is dispersed by the diffraction grating 113, reflected by the micro-mirror M3 included in the mirror array 120, and then output to the input/output port P1. The micro-mirror M3 is adjusted in angle α about the X-axis and angle β about the Y-axis so as to achieve such an optical path.

FIG. 4 illustrates the configuration of the optical axis adjusting system 1000. The optical axis adjusting system 1000 includes a variable wavelength light source 1, a light selector 2, and a light power meter 8. Communication light having passed through the light selector 2 is input to the optical component 110 through the optical fiber 10. The wavelength selectable switch 100 switches the optical path for the communication light, the communication light is input to the light power meter 8 through the optical fiber 10. It should be noted that a target mask 130 is disposed in place of the mirror array 120 in the optical axis adjusting system 1000. The target mask 130 is disposed facing the optical component 110 in place of a mirror that reflects the communication light having passed through the optical component 110 in a desired direction, that is, the mirror array 120. That is, the target mask 130 is a plate member that transmits and reflects the communication light. The light power meter 8 can acquire information on the optical characteristics of the reflected light.

As illustrated in FIG. 4, the optical axis adjusting system 1000 includes the camera 3 disposed on the back side of the target mask 130. The camera 3 is an example of a photographing unit, and photographs spot light that appears on the target mask 130 when the target mask 130 is irradiated with the communication light. The camera 3 includes a lens portion 3a and an illuminator 4 that provides coaxial vertical illumination. The camera 3 images transmitted infrared light in the communication wavelength band and illumination light in the visible light band. Thus, the camera 3 is an infrared camera having a sensitivity in the infrared band and the visible light band.

The optical axis adjusting system 1000 also includes an optical component positioning mechanism 5 that positions each component included in the optical component 110, a target mask positioning mechanism 6 that positions the target mask 130, and a camera positioning mechanism 7 that positions the camera 3. The optical component positioning mechanism 5 positions the optical fiber array 111, the micro-lens array 112, the condensing lens 114, and the correcting lens 115 included in the optical component 110. The optical component positioning mechanism 5 includes a motor actuator for each component, and drives the motor actuator to vary the position, the angle, and so forth of the component.

The optical axis adjusting system 1000 includes a control section 9. The control section 9 is electrically connected to the variable wavelength light source 1, the light selector 2, the camera 3, the optical component positioning mechanism 5, the target mask positioning mechanism 6, the camera positioning mechanism 7, and the light power meter 8.

In the embodiment, a personal computer (PC) is used as an example of the control section 9. The control section 9 performs positioning control of the optical component positioning mechanism 5, the target mask positioning mechanism 6, and the camera positioning mechanism 7 on the basis of the photographing information acquired by the camera 3 and the information on the optical characteristics of the reflected light reflected by the target mask 130.

The variable wavelength light source 1 generates single-wavelength light that corresponds to a wavelength channel in the communication wavelength band and swept-wavelength light. When the single-wavelength light is input to the wavelength selectable switch 100, spot light condensed at one point appears on the reflective surface of the mirror array 120. In the optical axis adjustment, the position of the spot light is matched with the center of the mirror. During this operation, the target mask 130 is disposed in the wavelength selectable switch 100 included in the optical axis adjusting system 1000. The target mask 130 is disposed in place of the mirror array 120.

The light selector 2 is placed between the variable wavelength light source 1 and the wavelength selectable switch 100 to switch input between the plurality of optical fibers. The light selector 2 selects one of the optical fibers 10 to cause the communication light emitted by the variable wavelength light source 1 to pass through. The communication light having passed through the light selector 2 is input to the selected one of the optical fibers 10 of the optical fiber array 111 forming the input/output ports.

In order to input single-wavelength communication light into the wavelength selectable switch 100, first, the variable wavelength light source 1 generates communication light at λn. Then, the light selector 2 selects an input/output port Pn to be connected to the wavelength selectable switch 100. This allows the single-wavelength communication light to be input to the wavelength selectable switch 100.

Output light reflected by the target mask 130 in the wavelength selectable switch 100 is introduced into the light power meter 8. The light power meter 8 measures the light intensity. Specifically, the light power meter 8 measures an Insertion Loss (IL) which represents the ratio of the amount of light output from the wavelength selectable switch 100 with respect to the amount of light input to the wavelength selectable switch 100. In the optical axis adjustment, the posture of the optical component 110 is adjusted so as to minimize the insertion loss IL, that is, to maximize the amount of light reflected by the target mask 130 which is stationary. The insertion loss (IL) is included in the optical characteristics.

As discussed above, the target mask 130 is disposed in place of the mirror array 120. Here, the target mask 130 will be described in detail with reference to FIGS. 5A to 5C. FIG. 5A is a front view of the target mask 130. FIG. 5B is a side view of the target mask 130. FIG. 5C illustrates examples of identification numbers affixed to target frames F1, F2, F3, F4, and F5 included in the target mask 130.

The target mask 130 is grasped by the target mask positioning mechanism 6 to be disposed at a position equivalent to the mirror array 120. After the optical axis is roughly adjusted using the target mask 130, the target mask 130 is replaced with the mirror array 120 which is an original constituent component to more precisely adjust the optical axis in a method according to the related art.

The target mask 130 is formed as a semi-transparent half mirror by coating a transparent glass substrate 131 with a vapor-deposited layer 132. The semi-transparent half mirror transmits some of input communication light, that is, input light, to the back side of the target mask 130, and reflects other of the input light. With some of the input light transmitted to the back side of the target mask 130, the camera 3 can photograph spot light that appears on the target mask 130.

The vapor-deposited layer 132 may be formed by general metal film coating. The vapor-deposited layer 132 disclosed herein is provided by forming a thin film of chromium and chromium oxide (Cr+Cr₂O₃) on the glass substrate 131, for example. The vapor-deposited layer 132 forms the target frames F1 to F5 with different thicknesses. Specifically, the target frames F1 to F5 are formed by vapor-depositing a material to a large thickness in the shape of a rectangular frame as illustrated in FIGS. 5A and 5B. The target frames F1 to F5 are provided to be equivalent to the arrangement of the micro-mirrors M1 to M5 included in the mirror array 120. As with the mirror array 120, the target frames F1 to F5 correspond to the number of channels in the communication wavelength band.

The shape of the target frames is not limited to a rectangular shape. For example, L-shaped thick-film portions may be vapor-deposited at the four corners. Alternatively, dot-like thick-film portions may be vapor-deposited at the four corners. In short, it is only necessary that the target frames should allow recognition of positions corresponding to the relevant micro-mirrors MN. Thus, it is not necessary to prepare target frames corresponding to all the micro-mirrors. The target frames may be provided only at positions corresponding to micro-mirrors that reflect light at specific wavelengths, or may be provided for every of the several micro-mirrors.

As illustrated in FIG. 5C, visible identification numbers “1”, “2”, “3”, . . . corresponding to the channel numbers are affixed in the vicinity of the target frames F1 to F5. The identification numbers may be used as indices indicating which target frame FN is being photographed by the camera 3. Therefore, identification methods other than the identification numbers may be adopted. For example, letters such as “A”, “B”, . . . may be affixed to the target frames. Alternatively, different symbols may be affixed to the target frames.

When communication light indicated by L1 and L2 in FIG. 4 is input to the target mask 130, the target mask 130 reflects the communication light to output light as indicated by L4 and L5. At the same time, the target mask 130 transmits light as indicated by L3 in FIG. 4.

Next, the positional relationship between the target mask 130 and the camera 3 will be described with reference to FIGS. 6A and 6B. FIG. 6A is a side view of the wavelength selectable switch 100, that is, a view seen along the X-axis. FIG. 6B is a plan view of the wavelength selectable switch 100, that is, a view seen along the Y-axis.

The camera 3 is disposed on the back side of the target mask 130, and images a portion of the target mask 130 in an enlarged scale. As illustrated in FIG. 4, the camera 3 is held by the camera positioning mechanism 7, and is moved to a position at which it images the target mask 130 by the camera positioning mechanism 7. That is, the camera 3 is moved to a position at which it images the light transmitted through the target mask 130 on the optical axis of the wavelength selectable switch 100.

During the optical axis adjustment, the reflection angle of the target mask 130 is set with reference to the center optical axis of the optical component 110. Thus, when adjusting the optical axis of the wavelength selectable switch 100 equipped with the five micro-mirrors M1 to M5 as illustrated in FIGS. 2A and 2B, for example, the optical axis of light at 23 input to the micro-mirror M3 is defined as the center optical axis. That is, the communication light at a wavelength 23 input to the input/output port P3 is equivalent to the center position of the lens array 120, and therefore the optical axis of the communication light input to the micro-mirror M3 is defined as the center optical axis.

When the number of micro-mirrors is even, the center optical axis is calculated using an appropriate correction coefficient.

The optical axis adjusting system 1000 according to the embodiment adjusts the target mask 130 in angle α about the X-axis and angle β about the Y-axis such that the optical axis of light input to the micro-mirror M3 is appropriately reflected by the target mask 130.

As illustrated in FIG. 6B, the camera 3 is installed on the back side of the micro-mirror M3. The micro-mirror M3 receives the communication light, the optical axis of which is selected as the center optical axis as discussed above. The camera 3 photographs the communication light transmitted through the target frame F3, specifically, spot light incident on the target frame F3. The camera 3 images a portion of the target mask 130 in an enlarged scale to enhance the image resolution. Thus, as illustrated in FIG. 6B, the imaging is performed with the camera 3 itself moved in the direction in which the channels are arranged.

In this way, the camera 3 photographs the spot light incident on the micro-mirror, which could not be directly observed using the mirror array 120 as an original component, as transmitted light. This consequently makes it possible to adequately adjust the position of the spot light, which is the position of the optical axis. The control section 9 issues a positioning command for the optical component positioning mechanism 5 on the basis of the photographing information acquired by the camera 3.

Next, an optical axis adjusting method for an optical device performed by the optical axis adjusting system 1000 described above will be described.

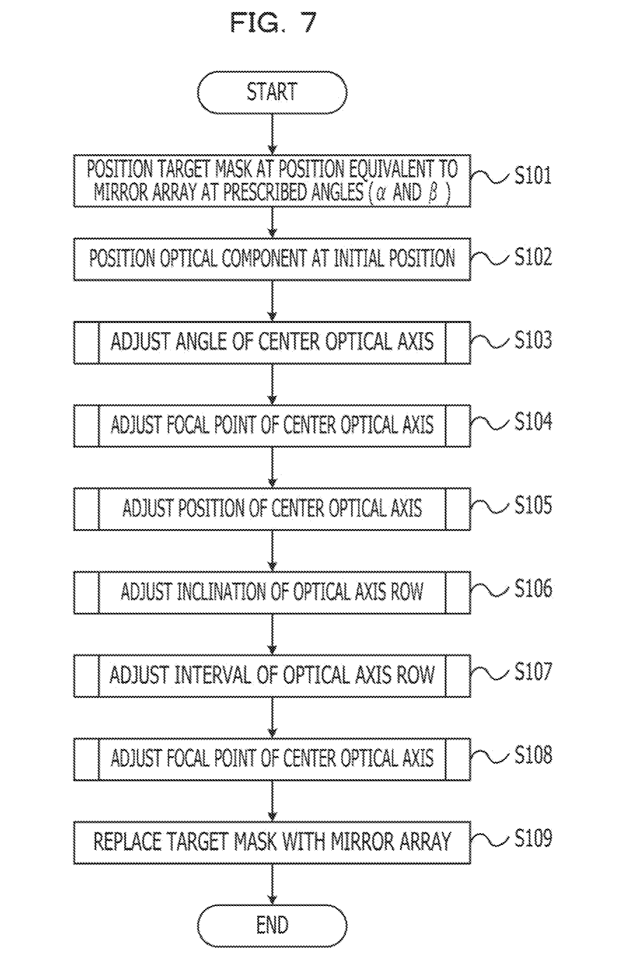

FIG. 7 illustrates an optical axis adjusting method. First, in step S101, the target mask 130 which transmits communication light is disposed facing the optical component 110 in place of a mirror that reflects the communication light having passed through the optical component 110 in a desired direction, that is, the mirror array 120. Specifically, the installation angle of the target mask 130 is adjusted to the angle α and the angle β of the mirror array 120 set by the wavelength selectable switch 100 as an end product. The angle adjustment is performed by driving the target mask positioning mechanism 6 on the basis of a command from the control section 9.

In step S102 following step S101, the optical component 110 is moved to an initial position. Steps S101 and S102 may be performed in the reverse order.

The optical axis is adjusted by performing various positioning operations for the optical component 110 as described below. In order to adjust the optical axis, communication light emitted from the variable wavelength light source 1 is caused to pass through the optical component 110 so that the target mask 130 is irradiated with the communication light having passed through the optical component 110. Then, the control section 9 positions the optical component 110 in consideration of information on the optical characteristics of reflected light reflected by the target mask 130, for example an output value of the light power meter 8.

Also, the camera 3 photographs spot light incident on the target mask 130 from the back side of the target mask 130. Then, the control section 9 positions the optical component 110 on the basis of acquired photographing information, specifically information on the photographed spot light.

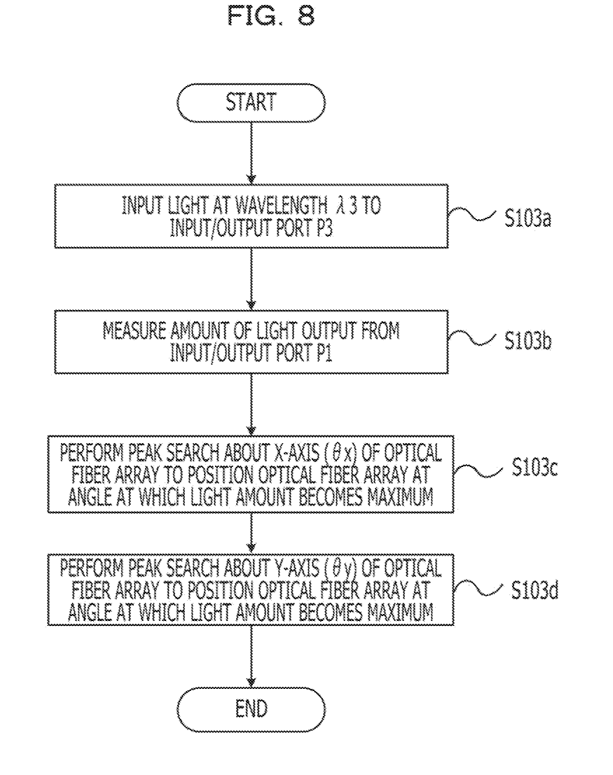

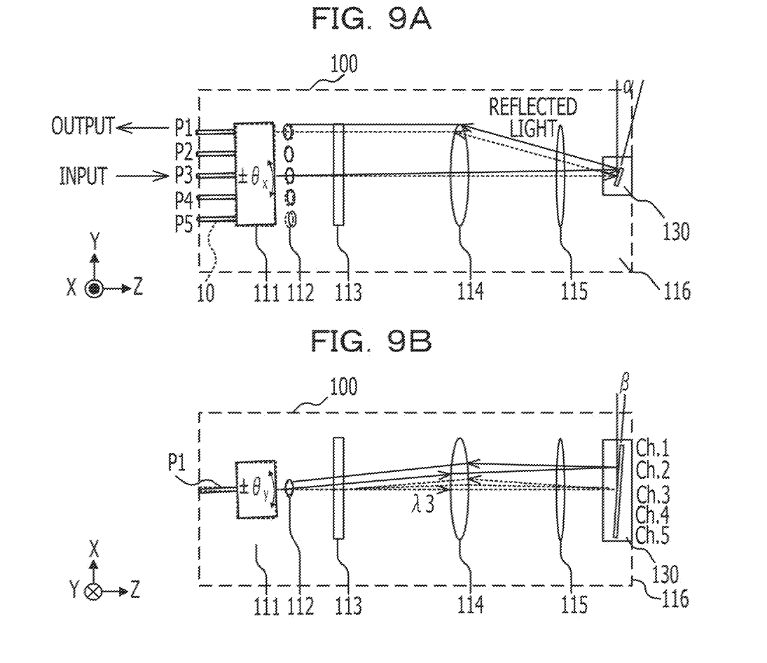

In step S103 following steps S101 and S102, the control section 9 adjusts the angle of the center optical axis. The angle of the center optical axis is adjusted by adjusting the angle of the optical fiber array 111. FIG. 8 illustrates an angle adjusting method for the optical fiber array 111. FIGS. 9A and 9B illustrate the angle adjustment for the optical fiber array 111. The angle adjustment for the optical fiber array 111 will be described below with reference to FIGS. 8, 9A, and 9B.

In step S103a, the control section 9 issues a command for the light selector 2 to input communication light at a wavelength λ3 to the input/output port P3. Then, in step S103b, the control section 9 measures the output light amount of reflected light returned to the input/output port P3 using the light power meter 8.

In step S103c, the control section 9 determines an angle θx about the X-axis of the optical fiber array 111 illustrated in FIG. 9A. The angle θx is determined using a peak search. That is, an angle at which the light amount becomes a maximum value is detected using a peak search to position the optical fiber array 111 at the detected angle.

Then, in step S103d, the control section 9 determines an angle θy about the Y-axis of the optical fiber array 111 illustrated in FIG. 9B. The angle θy is determined using a peak search. That is, an angle at which the light amount becomes a maximum value is detected using a peak search to position the optical fiber array 111 at the detected angle.

Steps S103c and S103d may be performed in the reverse order.

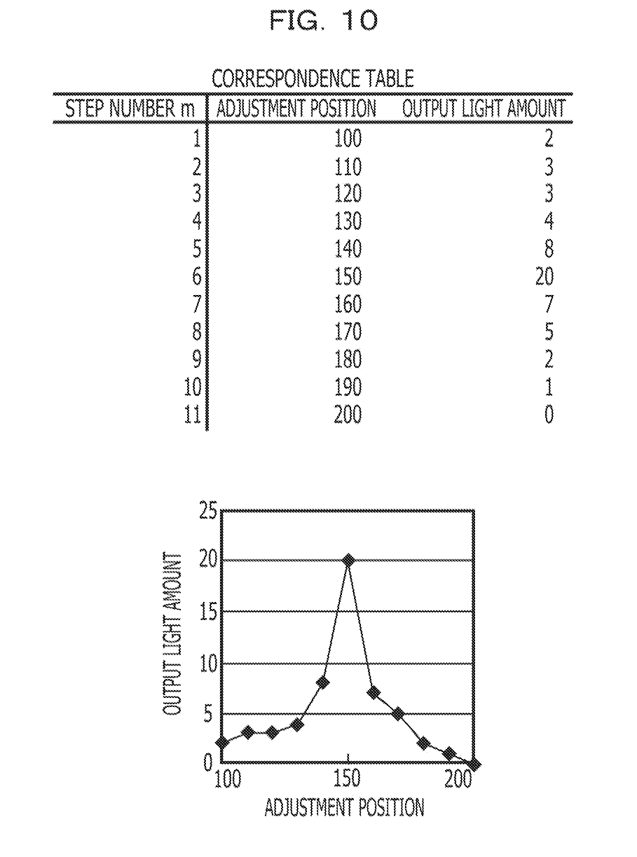

The angle of the optical fiber array 111 is adjusted using the peak search as described above. The peak search is also utilized to adjust the focal point of the center optical axis in step S104 to be discussed later. An example of the peak search will be described with reference to FIG. 10.

The optical axis is adjusted such that optimum reflected light is obtained from the target mask 130 disposed in place of the mirror array 120. That is, various components included in the optical component 110 are adjusted such that the insertion loss IL becomes minimized.

The minimum insertion loss IL may be obtained by determining the position of the optical components such that the amount of light reflected by the target mask 130 becomes maximized, and may be achieved by performing a peak search using a correspondence table defining the correspondence between the adjustment position and the output light amount of the reflected light.

An upper portion of FIG. 10 illustrates a correspondence table, and a lower portion of FIG. 10 illustrates a graph indicating the relationship between the adjustment position and the output light amount.

The motor actuator of the optical component positioning mechanism 5 varies the adjustment position for each step number m. For example, as illustrated in FIG. 10, the adjustment position is 100 when the step number is 1, and the adjustment position is 110 when the step number is 2. The adjustment position may be an angle, a horizontal position, or a vertical position, for example.

The correspondence table is prepared by reading the output value of the light power meter 8 for each step number m to record the output light amount.

In the example illustrated in FIG. 10, the output light amount has a maximum value of 20 when the adjustment position is 150. This makes it possible to determine the position of the components included in the optical component 110 by setting the adjustment position to 150.

The angle adjustment in step S103 may be performed using the peak search described above.

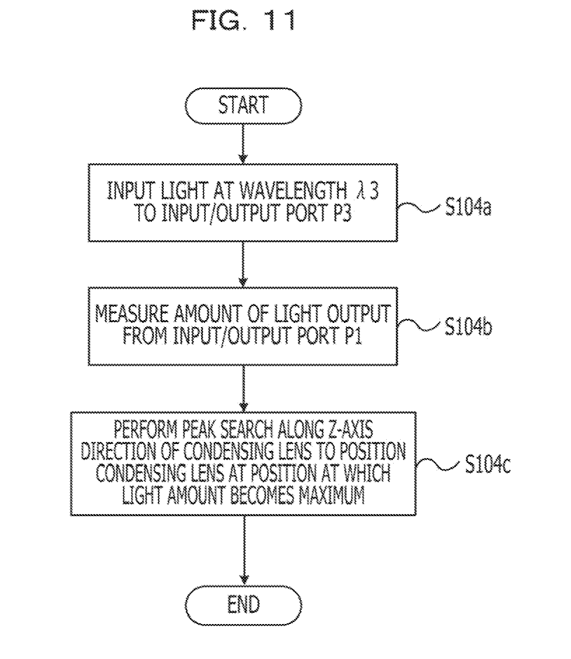

In step S104, the control section 9 adjusts the focal point of the center optical axis. The focal point on the target mask 130 is varied by adjusting the position of the condensing lens 114 in the direction of the optical axis. Thus, the condensing lens 114 is adjusted to a position at which the insertion loss IL is minimized. FIG. 11 illustrates a focal point adjusting method for the condensing lens 114.

In step S104a, the control section 9 issues a command for the light selector 2 to input communication light at a wavelength 23 to the input/output port P3. Then, in step S104b, the control section 9 measures the output light amount of reflected light returned to the input/output port P1 using the light power meter 8.

In step S104c, the control section 9 determines the position of the condensing lens 114 in the Z-axis direction. In this event, the peak search discussed above is used. That is, a position at which the light amount is maximized is detected using a peak search to position the condensing lens 114 at the detected position.

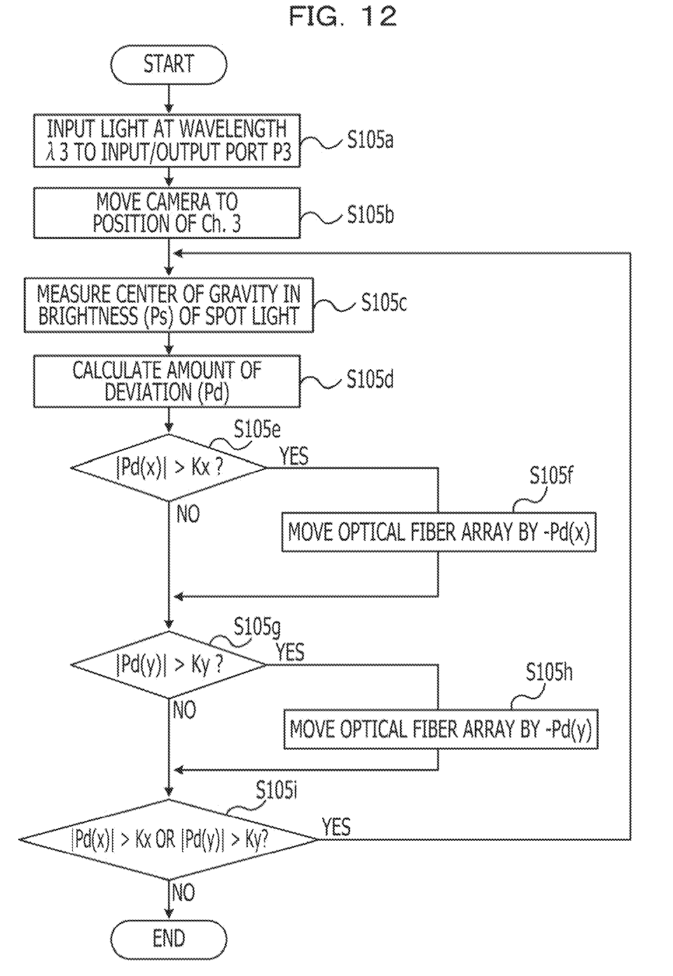

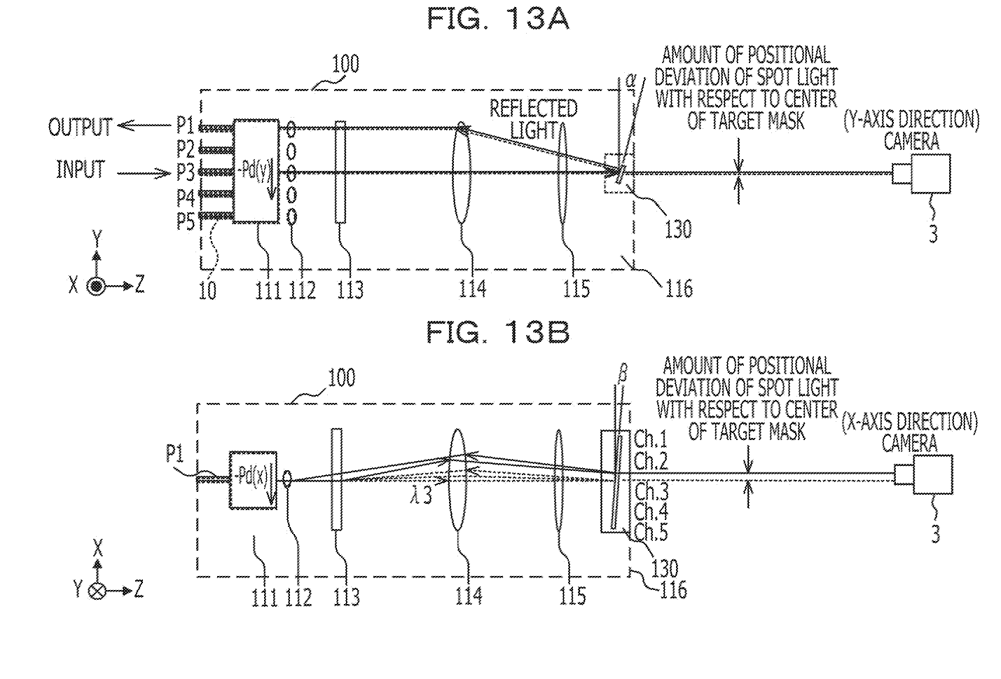

In step S105 following step S104, the control section 9 adjusts the position of the center optical axis by moving the optical fiber array 111 in the X-axis direction and the Y-axis direction. Deviation of the optical fiber array 111 is adjusted on the basis of the information on the spot light photographed by the camera 3. FIG. 12 illustrates a position adjusting method for the optical fiber array 111. FIGS. 13A and 13B illustrate the optical fiber array 111 during position adjustment.

In step S105a, the control section 9 issues a command for the light selector 2 to input communication light at a wavelength λ3 to the input/output port P3. Thereafter, in step S105b, the control section 9 issues a command for the camera positioning mechanism 7 to move the camera 3 to the position of Ch. 3.

In steps S105c and S105d, the control section 9 calculates the amount of deviation (Pd) of the spot light. In order to calculate the amount of deviation (Pd) of the spot light, first, communication light emitted from the variable wavelength light source 1 is caused to pass through the optical component 110 so that the target mask 130 is irradiated with the communication light having passed through the optical component 110. The camera 3 photographs spot light incident on the target mask 130 from the back side of the target mask 130. The control section 9 measures the center of gravity in brightness (Ps) of the spot light on the basis of acquired photographing information, specifically information on the photographed spot light, to calculate the amount of deviation (Pd) of the spot light on the basis of the center of gravity in brightness (Ps).

The control section 9 obtains information on the spot light from the photographing information from the camera 3 by performing the following processes.

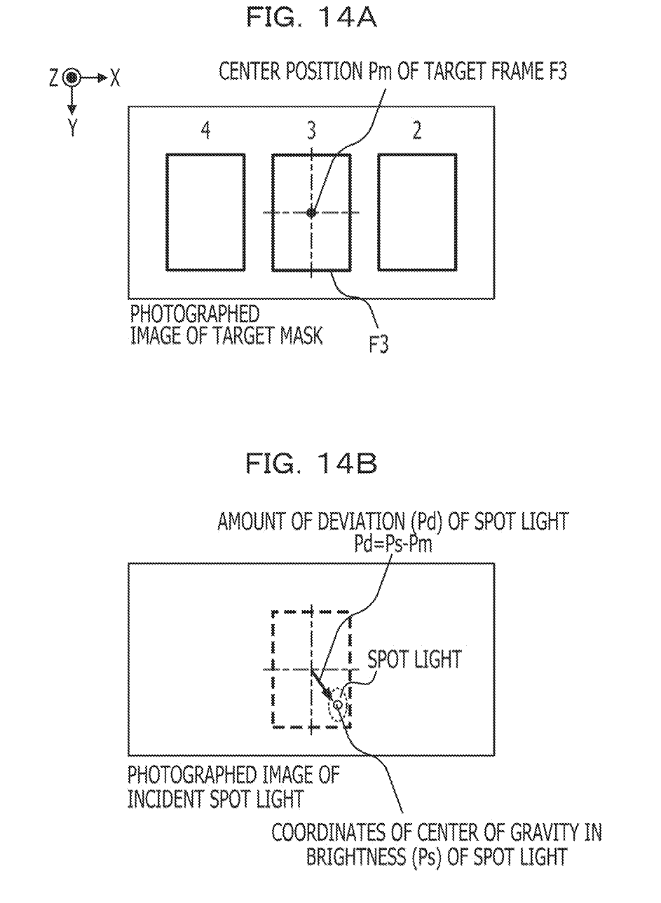

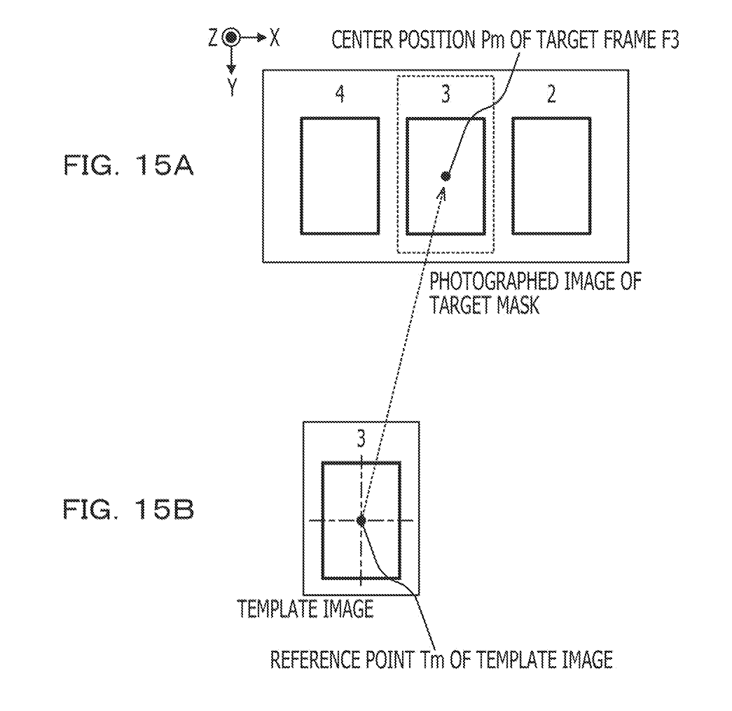

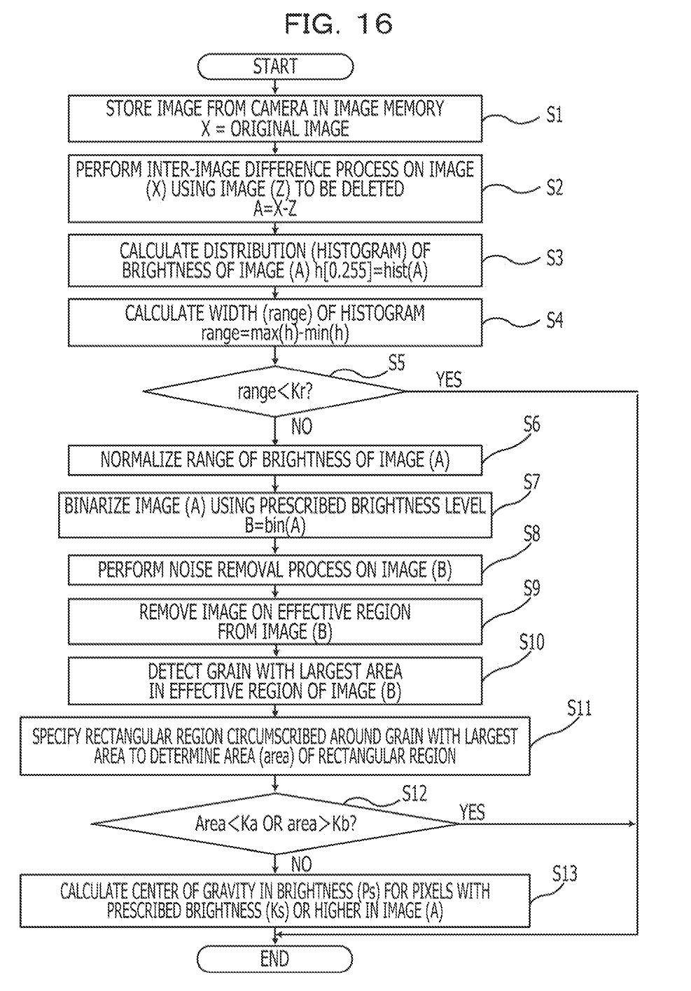

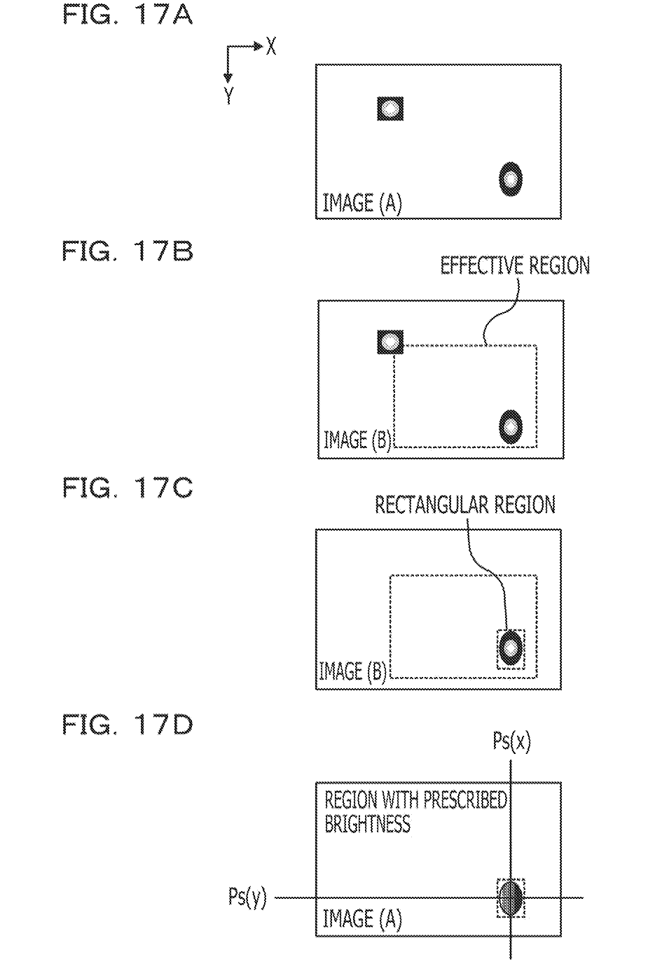

FIGS. 14A and 14B illustrate the photographing information. FIGS. 15A and 15B illustrate a recognition process for the target mask. FIG. 16 illustrates a recognition processing method for the spot light. FIGS. 17A to 17D illustrate a recognition process for the spot light. The photographing information from the camera 3 is processed by the control section 9.

FIG. 14A illustrates an image of the target mask 130 photographed with no communication light emitted. In this state, the control section 9 obtains the center position Pm of the target frame F3. The center optical axis is adjusted so as to pass through the center position Pm. The center position Pm is calculated by performing a template matching process on a photographed image of the target mask 130 illustrated in FIG. 15A using a template image prepared in advance illustrated in FIG. 15B. In the template matching process, specifically, a search is made in an image to be searched, that is, the photographed image, to find an object to be recognized, that is, the template image. A reference point Tm in the found template image is defined as the center position Pm.

FIG. 14B illustrates an image of the spot light photographed with communication light emitted. The position of the spot light corresponds to variations in posture of the optical component 110.

The amount of deviation (Pd) of the spot light is represented as Pd=Ps−Pm. The amount of deviation (Pd) is calculated using image processing software stored in the control section 9. The amount of deviation (Pd) of the spot light is equivalent to the amount of deviation of the spot light with respect to the center of the target mask 130, that is, the amount of deviation of the spot light with respect to the center of the mirror array 120.

The method for measuring the coordinates of the center of gravity in brightness (Ps) of the spot light (step S105c) is illustrated in FIG. 16. First, in step S1, an image from the camera 3 is stored in an image memory in the control section 9. This image is defined as an original image X (hereinafter referred to as an “image (X)”). Then, in step S2, an inter-image difference process is performed to obtain an image between the image (X) and an image Z at a predefined level prepared in advance (hereinafter referred to an “image (Z)”). The image obtained as a result of the inter-image difference process is defined as an input shading image A (hereinafter referred to as an “image (A)”). FIG. 17A schematically illustrates the image (A).

In steps S3 to S5, the distribution (histogram) of the brightness of the image (A) is calculated to verify whether or the difference between the highest brightness and the lowest brightness is a prescribed value (Kr) or more. Specifically, in step S3, the brightness range of the image (A) is converted so as to range from a lowest brightness of 0 to a highest brightness of 255. In step S4, the width (range=max(h)-min(h)) of the histogram is calculated. Then, in step S5, it is determined whether or not range<Kr is met.

If the determination result is Yes in step S5, the control section 9 terminates the process. On the other hand, if the determination result is No in step S5, the control section 9 proceeds to step S6. In step S6, the range of the brightness of the image (A) is normalized. Then, in step S7, the control section 9 binarizes the image (A) using a prescribed brightness level (threshold). This results in a binarized image B (hereinafter referred to as an “image (B)”).

Next, in step S8, a noise removal process is performed on the image (B). Specifically, isolated-point noise provided in units of minimum pixels is removed from the image (B).

Next, in step S9, an image on an effective region is removed from the image (B). FIG. 17B illustrates the effective region in the image (B).

Next, in step S10, a grain with the largest area in the effective region is detected. Specifically, a block of continuous dots with the largest area is detected. Then, in step S11, a rectangular region circumscribed around the grain with the largest area detected in step S10 is specified as illustrated in FIG. 17C to determine the area of the rectangular region. Such a rectangular region is considered as the region of the spot light to calculate the center of gravity in brightness (Ps) in the region.

In step S12, it is determined whether or not the area falls within a prescribed range. In step S12, if area<Ka or area>Kb is met, that is, the area does not fall within the prescribed range, the determination result is Yes, and the process is terminated. On the other hand, if the area falls within the prescribed range, the determination result is No, and the process proceeds to step S13.

In step S13, the center of gravity in brightness (Ps) is calculated for pixels with the prescribed brightness (Ks) or higher in the rectangular region of the image (A). The center of gravity in brightness (Ps) can be represented by Ps(x) and Ps(y) as illustrated in FIG. 17D.

In step S105d, the control section 9 calculates the amount of deviation (Pd) of the spot light from the center of gravity in brightness (Ps) of the spot light. Specifically, the amount of deviation Pd(x) in the X-axis direction and the amount of deviation Pd(y) in the Y-axis direction are calculated from the relationship Pd=Ps−Pm.

In step S105e, the control section 9 determines whether or not the amount of deviation Pd(x) in the X-axis direction is more than a prescribed value Kx. The prescribed value Kx is an allowable value of the amount of deviation Pd(x) in the X-axis direction. If the determination result is Yes in step S105e, that is, the amount of deviation Pd(x) in the X-axis direction is more than the prescribed value Kx, the process proceeds to step S105f.

In step S105f, the control section 9 issues a command for the optical component positioning mechanism 5 to move the optical fiber array 111 by −Pd(x) as illustrated in FIG. 13B. Thereafter, the process proceeds to step S105g.

If the determination result is No in step S105e, that is, the amount of deviation Pd(x) in the X-axis direction is not more than the prescribed value Kx, the process directly proceeds to step S105g.

In step S105g, the control section 9 determines whether or not the amount of deviation Pd(y) in the Y-axis direction is more than a prescribed value Ky. The prescribed value Ky is an allowable value of the amount of deviation Pd(y) in the Y-axis direction. If the determination result is Yes in step S105g, that is, the amount of deviation Pd(y) in the Y-axis direction is more than the prescribed value Ky, the process proceeds to step S105h.

In step S105h, the control section 9 issues a command for the optical component positioning mechanism 5 to move the optical fiber array 111 by −Pd(y) as illustrated in FIG. 13A. Thereafter, the process proceeds to step S105i.

If the determination result is No in step S105g, that is, the amount of deviation Pd(y) in the Y-axis direction is not more than the prescribed value Ky, the process directly proceeds to step S105i.

The processes in steps S105e and S105f may be performed after the processes in steps S105g and S105h. Alternatively, the processes in steps S105e and S105f may be performed concurrently with the processes in steps S105g and S105h.

In step S105i, the control section 9 determines whether or not the amount of deviation Pd(x) in the X-axis direction is more than the prescribed value Kx and whether or not the amount of deviation Pd(y) in the Y-axis direction is more than the prescribed value Ky. If the determination result is Yes in step S105i, that is, at least one of the amount of deviation Pd(x) and the amount of deviation Pd(y) is more than the corresponding prescribed value, the process returns to step S105c.

On the other hand, if the determination result is No in step S105i, the process is terminated. That is, the processes in steps S105c to S105h are repeated until both the amount of deviation Pd(x) in the X-axis direction and the amount of deviation Pd(y) in the Y-axis direction become the respective prescribed values or less.

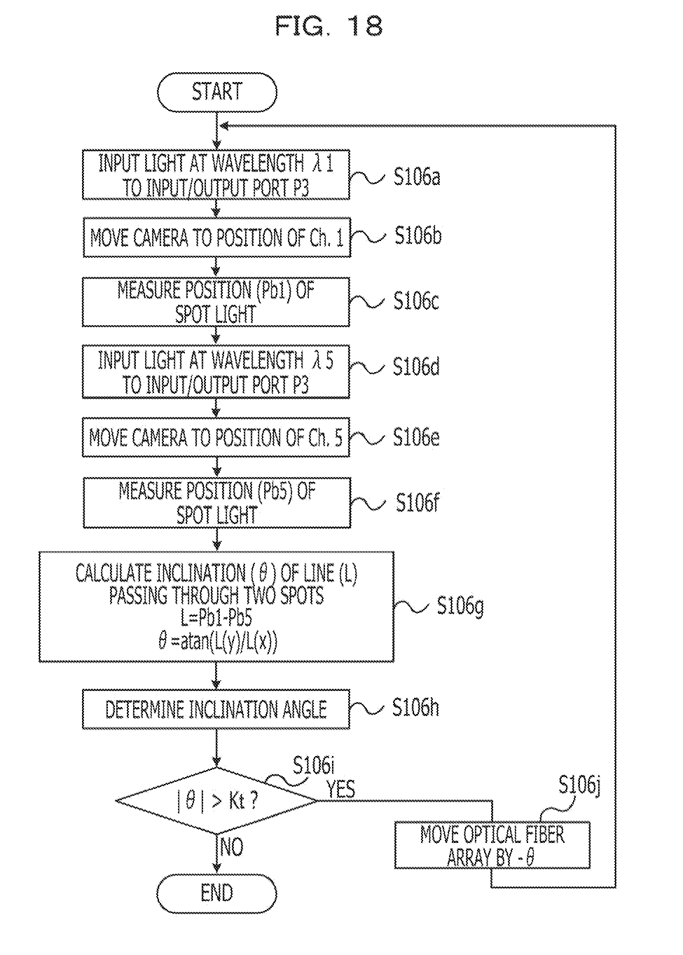

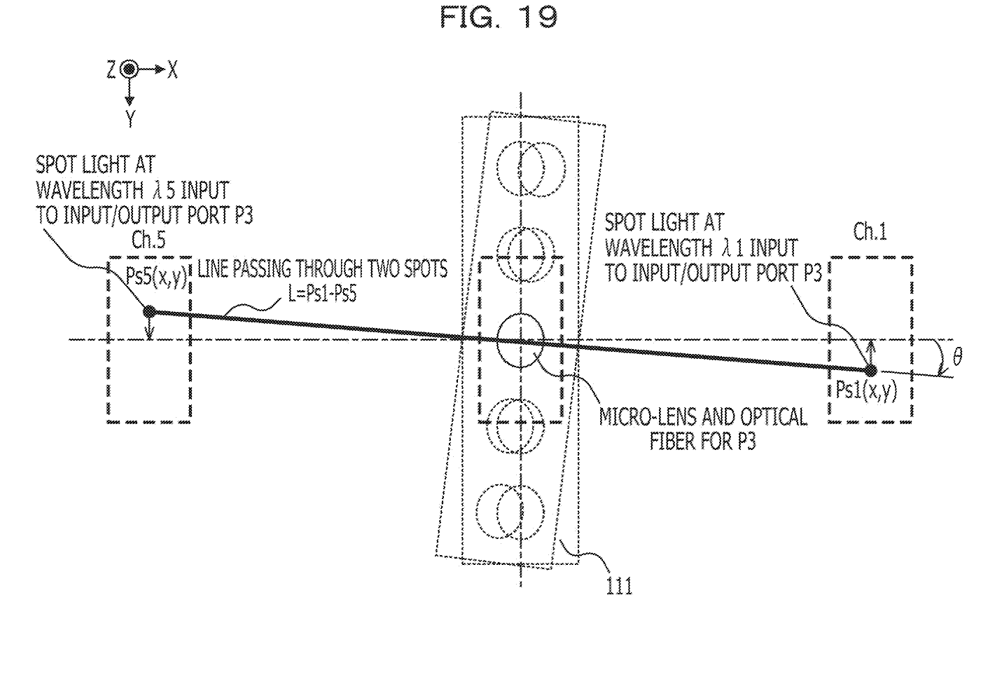

In step S106 following step S105, the control section 9 adjusts the inclination of the optical axis row. The inclination of the optical axis row is adjusted by adjusting the angle of the optical fiber array 111 about the Z-axis. FIG. 18 illustrates an inclination adjusting method for the optical fiber array 111. FIG. 19 illustrates the inclination adjustment for the optical fiber array 111. The adjustment of the inclination of the optical axis row performed by adjusting the inclination of the optical fiber array 111 will be described below with reference to FIGS. 18 and 19.

The inclination of the optical axis row is adjusted utilizing two spot lights provided across the center optical axis. Specifically, a light spot formed by communication light at λ1 input to Ch. 1 through the input/output port P3 and a light spot formed by communication light at λ5 input to Ch. 5 through the input/output port P3 are utilized.

Thus, first, in step S106a, the control section 9 issues a command for the light selector 2 to input communication light at a wavelength λ1 to the input/output port P3. Thereafter, in step S106b, the control section 9 issues a command for the camera positioning mechanism 7 to move the camera 3 to the position of Ch. 1.

Then, in step S106c, the position (Pb1) of the spot light, specifically the center of gravity in brightness (Pb1) of the spot light, is measured. Pb1 is measured in the same way as the center of gravity in brightness (Ps) discussed above.

In step S106d, the control section 9 issues a command for the light selector 2 to input communication light at a wavelength λ5 to the input/output port P3. Thereafter, in step S106e, the control section 9 issues a command for the camera positioning mechanism 7 to move the camera 3 to the position of Ch. 5.

Then, in step S106f, the position (Pb5) of the spot light, specifically the center of gravity in brightness (Pb5) of the spot light, is measured. Pb5 is measured in the same way as the center of gravity in brightness (Ps) discussed above.

After measuring Pb1 and Pb5 as described above, the control section 9 proceeds to step S106g. In step S106g, the control section 9 calculates the inclination (θ) of a line (L) passing through the two spots Pb1 and Pb5 illustrated in FIG. 19. The inclination (θ) is calculated by the following formula:

θ=a tan(L(y)/L(x))

Then, in step S106h, the control section 9 starts determination of the inclination angle. In step S106i, the control section 9 determines whether or not the inclination (θ) is more than a predetermined value Kt. If the determination result is Yes in step S106i, that is, the inclination (θ) is more than the prescribed value Kt, the process proceeds to step S106j. Then, in step S106j, the control section 9 issues a command for the optical component positioning mechanism 5 to move the optical fiber array 111 by −θ as illustrated in FIG. 19. Thereafter, the process returns to step S106a.

On the other hand, if the determination result is No in step S106i, the process is terminated. That is, the processes in steps S106a to S106j are repeated until the inclination (θ) becomes the prescribed value Kt or less.

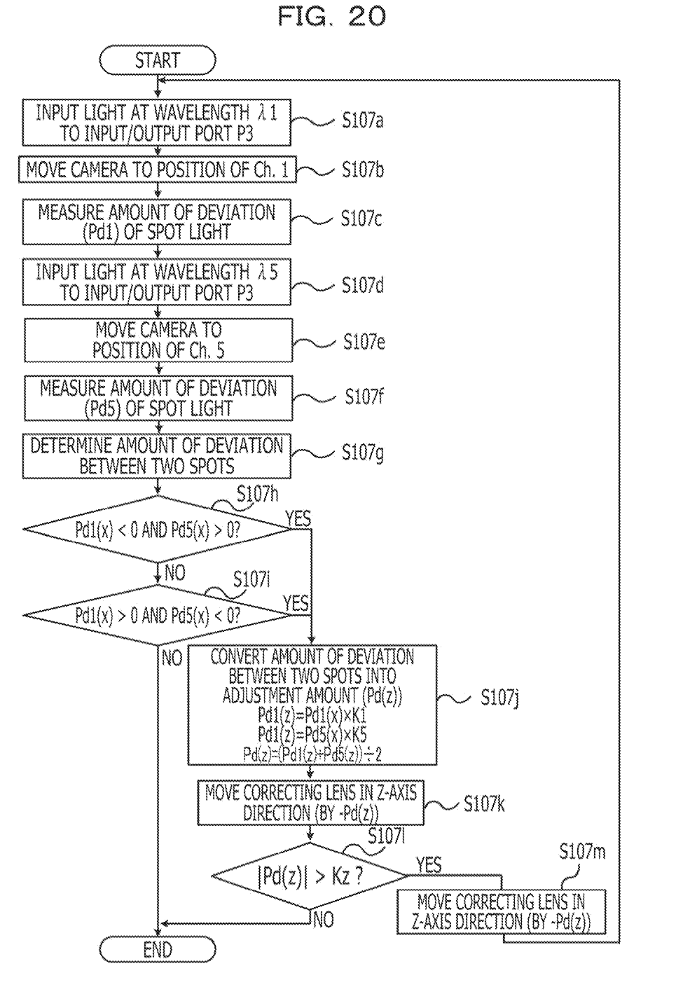

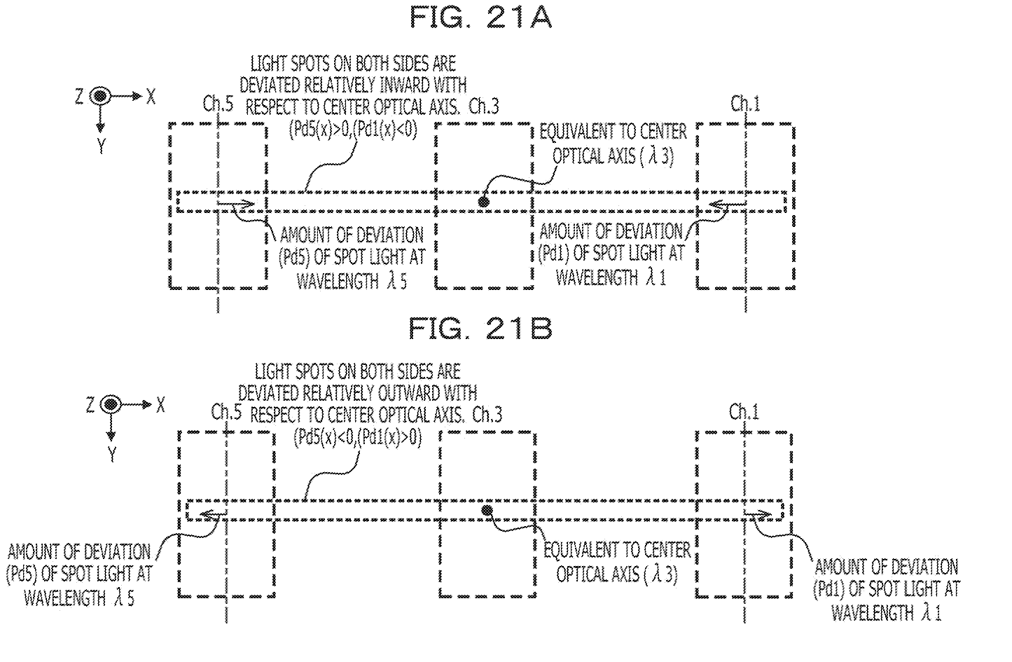

In step S107 following step S106, the control section 9 adjusts the interval of the optical axis row. The interval of the optical axis row is adjusted by adjusting the interval between the condensing lens 114 and the correcting lens 115. FIG. 20 illustrates a method for adjusting the interval between the condensing lens 114 and the correcting lens 115. FIGS. 21A and 21B illustrate adjustment of the interval between the condensing lens 114 and the correcting lens 115. The adjustment of the interval of the optical axis row performed by adjusting the interval between the condensing lens 114 and the correcting lens 115 will be described below with reference to FIGS. 20, 21A, and 21B.

As with the condensing lens 114, the focal point of the correcting lens 115 is varied on the condensing surface of the mirror array 120 when the position of the correcting lens 115 is varied in the direction of the optical axis (Z-axis). The correcting lens 115 has a long focal length, and thus the focal point of the correcting lens 115 is not varied significantly. The correcting lens 115 has a function of adjusting the interval between locations across the center optical axis. For example, the correcting lens 115 has a function of adjusting the interval between the center optical axis and the spot light at Ch. 1 and the interval between the center optical axis and the spot light at Ch. 5 in the case where the center optical axis is set at Ch. 3.

The interval of the optical axis row is adjusted utilizing two spot lights provided across the center optical axis. Specifically, a light spot formed by communication light at λ1 input to Ch. 1 through the input/output port P3 and a light spot formed by communication light at λ5 input to Ch. 5 through the input/output port P3 are utilized. It is intended to utilize spot lights that are symmetric with respect to the center optical axis.

Thus, first, in step S107a, the control section 9 issues a command for the light selector 2 to input communication light at a wavelength λ1 to the input/output port P3. Thereafter, in step S107b, the control section 9 issues a command for the camera positioning mechanism 7 to move the camera 3 to the position of Ch. 1.

Then, in step S107c, the amount of deviation (Pd1) of the spot light, that is, the position (Pb1) of the spot light, is measured. As described in relation to step S106c, the position (Pd1) of the spot light is calculated by measuring the center of gravity in brightness (Pb1) of the spot light. Pb1 is measured in the same way as the center of gravity in brightness (Ps) discussed above.

In step S107d, the control section 9 issues a command for the light selector 2 to input communication light at a wavelength λ5 to the input/output port P3. Thereafter, in step S107e, the control section 9 issues a command for the camera positioning mechanism 7 to move the camera 3 to the position of Ch. 5.

Then, in step S107f, the amount of deviation (Pd5) of the spot light, that is, the position (Pb5) of the spot light, is measured. As described in relation to step S106f, the position (Pd5) of the spot light is calculated by measuring the center of gravity in brightness (Pb5) of the spot light. Pb5 is measured in the same way as the center of gravity in brightness (Ps) discussed above.

In step S107h, the control section 9 determines whether or not both Pd1(x)<0 and Pd5(x)>0 are met. Pd1(x) is a component of the position (Pd1) of the spot light in the wavelength direction (X-axis direction). Pd5(x) is a component of the position (Pd5) of the spot light in the wavelength direction (X-axis direction). The determination performed in step S107h is to determine whether or not Pd1(x) and Pd5(x) are brought closer to the center optical axis as illustrated in FIG. 21A. If the determination result is Yes in step S107h, that is, it is determined that Pd1(x) and Pd5(x) are brought closer to the center optical axis, the process proceeds to step S107j. On the other hand, if the determination result is No in step S107h, the process proceeds to step S107i.

In step S107i, the control section 9 determines whether or not both Pd1(x)>0 and Pd5(x)<0 are met. The determination performed in step S107i is to determine whether or not Pd1(x) and Pd5(x) are brought away from the center optical axis as illustrated in FIG. 21B. If the determination result is Yes in step S107i, that is, it is determined that Pd1(x) and Pd5(x) are brought away from the center optical axis, the process proceeds to step S107j. On the other hand, if the determination result is No in step S107h, the interval of the optical axis row has been adjusted appropriately, and thus the process is terminated.

In step S107j, the control section 9 respectively converts the amounts of deviation Pd1 and Pd5 into adjustment amounts (Pd(z)) for the interval between the condensing lens 114 and the correcting lens 115.

The control section 9 converts Pd1(x) to calculate Pd1(z), and converts Pd5(x) to calculate Pd5(z). Specifically, the following conversions are performed:

Pd1(z)=Pd1(x)×K1

Pd5(z)=Pd5(x)×K5

where K1 and K5 are each a conversion coefficient.

Further, the control section 9 calculates Pd(z) from Pd1(z) and Pd5(z). Specifically, the following computation is performed:

Pd(z)=(Pd1(z)+Pd5(z))÷2

That is, the average of the converted values for the two spots, namely Pd1 and Pd5, is calculated.

Then, in step S107k, the control section 9 starts determination of the adjustment amount Pd(z).

In step S107l, the control section 9 determines whether or not the adjustment amount Pd(z) is more than a prescribed value Kz. If the determination result is Yes in step S1071, that is, the adjustment amount Pd(z) is more than the prescribed value Kz, the process proceeds to step S107m.

In step S107m, the control section 9 issues a command for the optical component positioning mechanism 5 to adjust the interval between the condensing lens 114 and the correcting lens 115. Specifically, the correcting lens 115 is moved by −Pd(z). Thereafter, the process proceeds to step S107a.

If the determination result is No in step S1071, that is, the adjustment amount Pd(z) is not more than the prescribed value Kz, the process is terminated. That is, the processes in steps S107a to S1071 are repeated until the adjustment amount Pd(z) becomes the prescribed value Kz or less.

In step S108 following step S107, the control section 9 adjusts the focal point of the center optical axis again in the same way as in step S104. This process is performed to adjust the focal point of the center optical axis again in consideration of a fact that the optical component 110 has undergone various adjustment processes after step S104. In some cases, this process may be omitted.

In step S109 following step S108, the target mask 130 is replaced with the mirror array 120. That is, the optical axis adjustment has almost been completed through the processes of step S108 and the previous steps. After the target mask 130 is replaced with the mirror array 120, final optical axis adjustment is performed using wavelength response characteristics as in the related art. In addition, an irradiation test is performed for the entire optical path. In the related art, it is difficult to adjust the optical axis with the mirror array 120 mounted because the amount of deviation of the optical axis is initially too large. In the embodiment, the optical axis is adjusted in advance using the optical axis adjusting system 1000, and therefore it is easy to perform final optical axis adjustment with the mirror array 120 mounted.

In the optical axis adjusting system 1000 according to the embodiment, the mirror array 120 provided in the wavelength selectable switch 100 is replaced with the target mask 130 to adjust the optical axis. Thus, the optical axis can be adjusted under conditions that are similar to the actual use state of the wavelength selectable switch 100, which allows the adjustment work to be performed efficiently.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that various changes, substitutions, and alterations could be made hereto without departing from the spirit and scope of the invention.

1. An optical axis adjusting apparatus for an optical device, comprising:
a drive unit moving an optical component through which communication light emitted from a light source passes;
a plate member disposed facing the optical component, the plate member allowing light to transmit through the plate member and reflecting light to the optical component;
a photographing unit disposed on a back side of the plate member, taking an image irradiated with the light transmitted through the plate member; and
a control section controlling the drive unit to move the optical component based on the image and information on optical characteristics of the light reflected by the plate member.

2. An optical axis adjusting method for an optical device, comprising:
disposing a plate member facing an optical component, the plate member transmitting light from the optical component and reflecting light to the optical component, the plate member being provided in place of a mirror that reflects the communication light in a desired direction;
irradiating the plate member with the light having passed through the optical component;
photographing spot light incident on the plate member from a back side of the plate member; and
moving the optical component based on information on the photographed spot light and information on optical characteristics of reflected light reflected by the plate member.
